(19) United States
(12) Patent Application Publication
(10) Pub. No.: US 2012/0047235 A1
(43) Pub. Date: Feb. 23, 2012

(54) METHOD OF DISPLAYING EVENT ON PORTABLE TERMINAL, APPARATUS THEREFOR, AND SYSTEM FOR PROVIDING THE SAME

(75) Inventors: Jung-Min BAN, Gyeongsangbuk-do (KR); Young-Hae KIM, Gyeonggi-do (KR)

(73) Assignee: SAMSUNG ELECTRONICS CO., LTD., Gyeonggi-Do (KR)

(21) Appl. No.: 13/212,281

(22) Filed: Aug. 18, 2011

(30) Foreign Application Priority Data
Aug. 18, 2010 (KR) 10-2010-0079880

(51) Int. Cl. G06F 15/16

(52) U.S. Cl. 709/219

(57) ABSTRACT

A wireless network system includes: a portable terminal for transmitting a request message for temporarily stopping a content file being currently reproduced and reproducing a content file corresponding to a predetermined time alarm event set based on position information to a Digital Media Renderer (DMR) by using an Application Programming Interface (API) of a wireless network if the predetermined time alarm event occurs; the DMR for temporarily stopping the content file being currently reproduced and reproducing the reproduction-requested content file in response to the request message; and an Access Point (AP) for controlling that the content file being reproduced by the DMR is transmitted to a plurality of digital devices using the API of the wireless network.

### CLAIM OF PRIORITY

This application claims priority under 35 U.S.C. §119 to an application entitled “Method of Displaying Event on Portable Terminal, Apparatus therefore, and System for Providing the Same” filed in the Korean Intellectual Property Office on Aug. 18, 2010 and assigned Serial No. 10-2010-0079880, the contents of which are incorporated herein by reference.

### BACKGROUND OF THE INVENTION

1. Field of the Invention

The present invention relates generally to displaying a specialized event, and more particularly, to displaying an event using a portable terminal for generating a predetermined alarm event at a specified time and transmitting a content file associated with the generated event to all devices existing in a network so that the devices can reproduce the content file.

2. Description of the Related Art

Followers of Muslims bow down 5 times a day facing in the direction of the Qiblah or Mecca, which is a sacred place for Islam, according to ritual called Salah. This bow is known as Azan, and its frequency are between dawn and sunrise, between noon and mid-afternoon, mid-afternoon and sunset, immediately after sunset, and between night and dawn.

For frequent travelers between countries or cities, the conventional alerting means is inconvenient due to a time zone difference. In a certain network environment of the type having a plurality of devices, the Azan times may be problematic as the user travels to a different time zone area, thus unable to correctly perceive the Azan times.

### SUMMARY OF THE INVENTION

An object of the present invention is to substantially solve at least the above problems and/or disadvantages and to provide at least the advantages below. Accordingly, the present invention provides displaying an event using a portable terminal for providing an Islamic Azan time calculated based on position information registered in the portable terminal regardless of movement between countries or cities along with a Qiblah direction, and simultaneously transmitting the Azan time to a network formed by surrounding devices so that the devices in the network can temporarily stop reproducing operations thereof and reproduce a content file associated with Azan.

According to one aspect of the present invention, a wireless network system includes: a portable terminal for transmitting a request message for temporarily stopping a content file being currently reproduced and, if the predetermined time alarm event occurs, reproducing a content file corresponding to a predetermined time alarm event set based on position information to a Digital Media Renderer (DMR) by using an Application Programming Interface (API) of a wireless network; the DMR for temporarily stopping the content file being currently reproduced and reproducing the reproduction-requested content file in response to the request message; and an Access Point (AP) for controlling that the content file being reproduced by the DMR and transmitted to a plurality of digital devices using the API of the wireless network.

According to another aspect of the present invention, a method of displaying an event using a portable terminal includes: identifying position information registered in the portable terminal; calculating a predetermined time based on the identified position information and setting an event occurring at the calculated time; and matching a predetermined content file to the set event, searching for at least one surrounding device capable of reproducing the content file, and transmitting to the found device the content file through an Application Programming Interface (API) of a wireless network when the event occurs.

According to further another aspect of the present invention, an apparatus for displaying an event using a portable terminal includes: a position information Data Base (DB) for registering, storing, and managing position information of a corresponding city of a corresponding country, which is identified through a user's input or periodically transmitted serving Base Station (BS) information; a calculator for calculating a predetermined time based on position information output from the position information DB; and a controller for setting an event occurring at the time calculated by the calculator, matching a predetermined content file to the set event, searching for at least one surrounding device capable of reproducing the content file, and transmitting to the found device the content file through an Application Programming Interface (API) of a wireless network when the event occurs.

### BRIEF DESCRIPTION OF THE DRAWINGS

The above features and advantages of the present invention will become more apparent from the following detailed description when taken in conjunction with the accompanying drawing in which:

FIG. 1 is a schematic configuration diagram of an entire system using a wireless network, which performs an event display service using a portable terminal, according to a preferred embodiment of the present invention;

FIG. 2 is a flowchart of a method of displaying an event using a portable terminal, according to a preferred embodiment of the present invention; and

FIG. 3 is a block diagram of an apparatus for displaying an event using a portable terminal, according to a preferred embodiment of the present invention.

### DETAILED DESCRIPTION OF THE INVENTION

The present invention provides technology of generating a predetermined time alarm event based on position information using a portable terminal and transmitting a content file associated with the generated event to all devices existing in a network in which the portable terminal is located so that the devices can reproduce the content file More particularly, the present invention provides technology of providing an Islamic Azan time calculated based on position information registered in the portable terminal regardless roaming between countries or cities along with a Qiblah direction, and also simultaneously making an environment for performing Azan by correctly perceiving the Azan times so that devices in a network can temporarily stop reproducing operations thereof and reproduce a content file associated with Azan using an authentication Application Programming Interface (API) of the network.

Prior to a detailed description of the present invention, it should be noted that a wireless network described in the specification utilizes various middlewares, such as Universal Plug and Play (UPnP), Home Audio Video Interoperability (HAVi), Jini, Video Electronics Standards Association (VESA), and Digital Living Network Alliance (DLNA). In DLNA, one of the middlewares focuses on sharing all of content provided from devices, such as a TV, a Video Cassette Recorder (VCR), a digital camera, and an audio system, and a DLNA system may be a wired or wireless system including a Digital Media Server (DMS), a Digital Media Player (DMP), a Digital Media Controller (DMC), and a Digital Media Renderer (DMR). Although such a DLNA system is illustrated in embodiments of the present invention for convenience of description, it is premised that the present invention is not limited thereto.

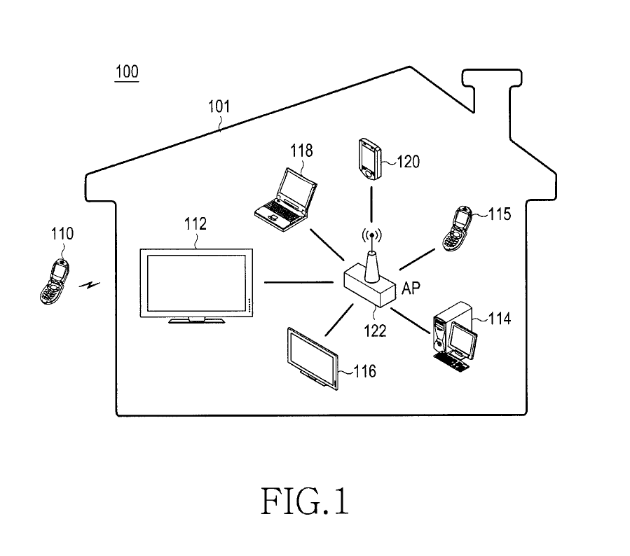

FIG. 1 is a schematic configuration diagram of an entire system using a wireless network, which performs an event display service using a portable terminal 110, according to a preferred embodiment of the present invention. It should be noted that the portable terminal according to a preferred embodiment of the present invention may be a mobile communication terminal, and it will be clearly understood by those of ordinary skill in the art that the portable terminal may be applied to all information communication devices, such as a digital broadcast terminal, a Personal Digital Assistant (PDA), a smart phone, a third generation (3G) terminal, e.g., an International Mobile Telecommunication 2000 (IMT-2000) terminal, a Wideband Code Division Multiple Access (WCDMA) terminal, a Global System for Mobile Communication Packet Radio Service (GSM/GPRS) terminal, and a Universal Mobile Telecommunication Service (UTMS) terminal, multimedia devices, and applications thereof.

Referring to FIG. 1, a DLNA system 100 to which the present invention is applied includes a home DLNA system 101 and the portable terminal 110 for performing the event display service by being connected to the home DLNA system 101.

As shown, the home DLNA system 101, for example, may include a DMS (e.g., a Personal Computer (PC)) 114 for storing a multimedia content file and providing it in response to a request, a plurality of Digital Media Players (DMPs) (e.g., a TV) 115 and 116 for executing digital media content provided through the DMS 114, a Digital Media Renderer (DMR) 112 for temporarily stopping a content file being currently reproduced and reproducing a content file reproduction-requested by the portable terminal 110 in response to a request message of the portable terminal 110, Digital Media Controllers (DMCs) 118 and 120 for requesting for a desired content file to be reproduced from among content files of the DMS 114, and an Access Point (AP) 122 for allowing devices, which desire to access the DLNA system 100, to access the DLNA system 100, and controlling that a content file being reproduced by the DMS 114 is transmitted to the DMR 112 the DMPs 115 and 116, and the DMCs 118 and 120 using a UPnP based authentication API of the DLNA system 100. The AP 112 can transmit a content file of a DMS 114 to a DMR 112, and the DMR 112 temporally stores a received content file and then plays the content file. As such, any of the devices in the home DLNA system 101 serve as the AP and the DMS.

The DLNA system 100 allows various kinds of devices connected in a DLNA network to share digital content. For example, content stored in the DMS 114 may be freely reproduced by the DMPs 115 and 116 and the DMCs 118 and 120 through the AP 122.

In operation, when a predetermined time alarm event set based on position information occurs, the portable terminal 110 transmits a request message for temporarily stopping a content file being currently reproduced and reproducing a content file corresponding to the event to the DMR 112 by using the UPnP based authentication API.

In more detail, position information of a corresponding city of a corresponding country, which is registered by a user or registered from an international telephone country code identification number registered through periodically transmitted serving Base Station (BS) information, is registered in the portable terminal 110. For example, when the user of the portable terminal 110 moves from Eastern states of the United States of America to Western states thereof, a current position of the user may be registered in the portable terminal 110 by directly registering a place name of the west area by the user, or may be receiving an international telephone country code identification number included in state information of a serving BS, which is periodically transmitted from the serving BS to the portable terminal 110 in an area in which the user is currently located. The registered place name is identified through a direct input of the user using a keypad (e.g., “New York”, “London”, or international telephone country code identification number “82” of Korea). Alternatively, when a place name or international telephone country code identification number input by the user is found in a position information Data Base (DB), the registered place name is identified through latitude and longitude information matched to the place name or international telephone country code identification number input by the user.

Predetermined times are calculated based on the identified position information, and an event occurring the calculated times is set. That is, when position information registered and identified in the portable terminal 110 is “New York”, sunrise/noon/sunset times of New York (i.e. Eastern Zone) are calculated, and predetermined times, i.e., Azan times, are calculated based on the calculated NY time zone. The Azan times are a series of divine service times performed in Islam five times a day, including FAJR (early morning) worshipping towards Qiblah between dawn and sunrise, DHUHR (noon) worshipping towards Qiblah between noon and mid-afternoon, ASR (late afternoon) worshipping towards Qiblah between mid-afternoon and sunset, MAGHRIB (evening) worshipping towards Qiblah immediately after sunset, and ISHA (late night) worshipping towards Qiblah between night and dawn.

For the user to attend a divine service according to these five Azan times, the portable terminal 110 outputs sunset/noon/sunrise times based on current position information, calculates Azan times based on the calculated times, and then sets different praying events occurring at the calculated Azan times. In this case, the event occurs five times a day according to the FAJR, DHUHR, ASR, MAGHRIB, and ISHA times. Here, the portable terminal 110 controls that a predetermined content file is matched to the event or events, and the predetermined content file is reproduced when such event occurs. In addition, the portable terminal 110 searches for at least one surrounding device capable of reproducing the predetermined content file and transmits the predetermined content file through an API of a network associated with the device when the event occurs for reproduction. The predetermined content file may include religious images relating to Koran, image information, and sound information associated with the Azan, etc.

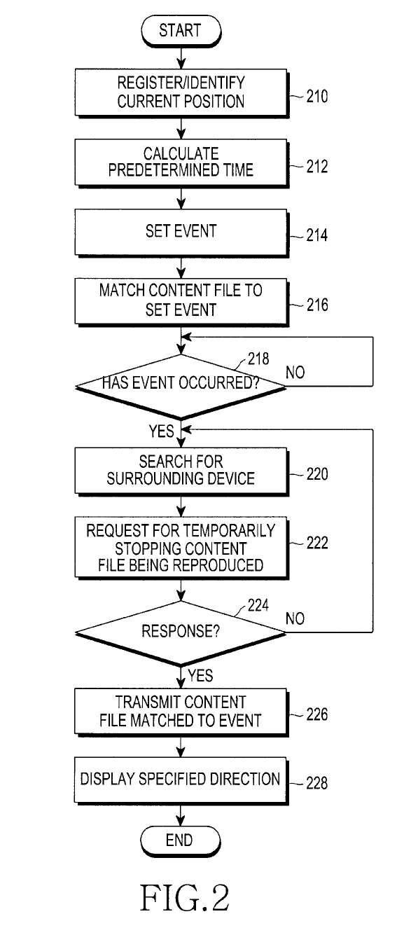

Hereinafter, a method of displaying an event using a portable terminal according to a preferred embodiment of the present invention will now be described in detail with reference to FIG. 2.

FIG. 2 is a flowchart of displaying an event using a portable terminal according to a preferred embodiment of the present invention.

Referring to FIG. 2, in step 210, position information of a corresponding city of a corresponding country is identified by directly registering position information of the portable terminal by a user, or automatically registering an international telephone country code identification number acquired from periodically transmitted serving BS information.

In step 212, predetermined times are calculated based on the position information identified in step 210. That is, sunrise/noon/sunset times are calculated from the position information registered in and identified by the portable terminal, and the predetermined times, i.e., Azan times, for a series of divine services performed in Islam five times a day are calculated based on the calculated sunrise/noon/sunset times.

In step 214, an event occurring at the times calculated in step 212 is set. Then, the event is set to occur at each Azan time periods in a given day.

In step 216, a predetermined content file is matched to the set event. The predetermined content file indicates a content file including the Koran, image information, and sound information associated with the Azan. Here, the content is stored in the portable terminal, and a user of the portable terminal may match one same content or different contents for each praying time. In step 218, it is checked whether the set event occurs, and if the set event occurs, the process proceeds to step 220.

In step 220, a surrounding device capable of reproducing the content file is searched for in a currently located network, for example, as shown in FIG. 1.

In step 222, a request message for temporarily stopping a content file being currently reproduced by the found device by using the authentication API of the DLNA system in step 220. Here, the found device indicates the DMR capable of reproducing the content file matched to the event, wherein the DMR receives a content file from the portable terminal and transmits the content file being currently reproduced therein to a plurality of digital devices included in the DLNA system by using the AP included in the DLNA system so that the plurality of digital devices can reproduce the content file.

In step 224, it is checked whether a response to the transmitted request message has been received, and if no response has been received from the DMR, the process proceeds back to step 220 to keep searching for a surrounding device capable of reproducing the content file. Otherwise, if a response has been received from the DMR, the process proceeds to step 226 to transmit the content file matched to the event to the DMR. In this case, the DMR temporarily stops the content file being currently reproduced therein and reproduces the content file reproduction-requested from the portable terminal in response to the request message in step 222. The content file being reproduced in the DMR is transmitted to the plurality of devices connected to the DLNA system including the DMR through the AP so that the plurality of devices can reproduce the content file.

After transmitting the content file in step 226, in step 228, a Qiblah direction displayed with bearings of east, west, south, and north on a position of magnetic north information acquired through a magnetic sensor provided in the terminal and position information acquired through a position information DB is displayed on the portable terminal. One skilled in the art would readily appreciate that determining direction is well known in the art that can be performed a variety of ways.

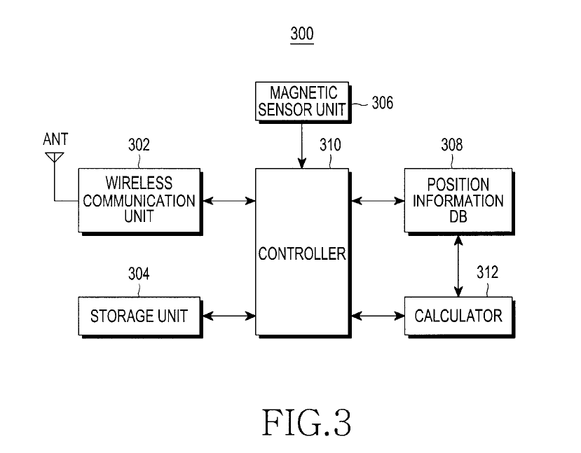

Hereinafter, an apparatus for displaying an event using a portable terminal according to a preferred embodiment of the present invention will now be described with reference to FIG. 3.

FIG. 3 is a block diagram of an apparatus 300 for displaying an event using a portable terminal according to a preferred embodiment of the present invention.

Referring to FIG. 3, although the apparatus 300 for displaying an event using the portable terminal includes a wireless communication unit 302, a storage unit 304, a magnetic sensor unit 306, a position information DB 308, a controller 310, and a calculator 312 in FIG. 3, an image display apparatus using the portable terminal may further include a camera, a speaker, and a microphone.

The wireless communication unit 302 receives a wireless download signal using an antenna and outputs download data obtained by demodulating the wireless download signal to the controller 310. In addition, the wireless communication unit 302 generates a wireless upload signal by modulating upload data input from the controller 310 and transmits the generated wireless upload signal in a wireless manner using an antenna. These modulation and demodulation may be performed in a Code Division Multiple Access (CDMA) method, a Frequency Division Multiplexing (FDM) method, a Time Division Multiplexing (TDM) method, or other protocols known by one skilled in this art.

The storage unit 304 stores various kinds of information selected according to user selection information, and user storage information. In addition, the storage unit, i.e., a memory, 304 may store programs for a process and control of the controller 310, perform a function for temporarily storing input/output data (e.g., a phonebook, a message, a media player, and a netbook), and store a plurality of image data and content files related to religious content to be displayed on a display unit of the portable terminal.

The position information DB 308 registers, stores, and manages position information of a corresponding city of a corresponding country through an international telephone country code identification number registered by a user or acquired through periodically transmitted state information of a serving BS.

The calculator 312 calculates predetermined religious time periods based on position information output from the position information DB 308. That is, sunrise/noon/sunset times are calculated from the position information output and identified from the position information DB 308, and the predetermined times, i.e., the Azan times that are a series of divine service times performed in Islam, are calculated based on the calculated sunrise/noon/sunset times. It should be noted that the calculator 312 is also capable of calculating other religious events other than Islam to serve as a reminder or reproduction of religious theme images or events in desired devices.

The magnetic sensor unit 306 detects magnetic north information anywhere so that a relative desired direction towards a Qiblah can be determined.

By setting an event occurring at the times calculated by the calculator 312, matching a predetermined content file to each set event, and searching for at least one surrounding device capable of reproducing the predetermined content file, the controller 310 controls the found device to transmit the predetermined content file through an API of a network when the set event occurs. Here, the controller 310 controls to generate a message in a format based on a corresponding protocol of the network including the found device, i.e., based on UPnP of a DLNA system, and set an access to the found device.

In addition, the controller 310 controls a display unit to display the Qiblah direction with bearings of east, west, south, and north on a position of the magnetic north information detected by the magnetic sensor unit 306 and the position information output from the position information DB 308.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

According to the present invention, by providing Islamic Azan times calculated based on position information registered in a portable terminal together with a Qiblah direction regardless of movement between countries or cities having different time zones and simultaneously transmitting the Azan times to surrounding devices at a desired location to reproduce a corresponding content file, an environment for correctly perceiving the Azan times and attending a divine service can be made. That is, the portable terminal changes the Islamic Azan time to the time of a particular city of a country that the mobile user is located and sends the event requesting the replay of the religious content files to the surrounding devices where the portable terminal is located or alternatively remotely located.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention include all embodiments falling within the scope of the appended claims.

What is claimed is:

1. A wireless network system having a plurality of digital devices, comprising:
a portable terminal for transmitting a request for temporarily stopping a content file being currently reproduced to at least one of the plurality of digital devices and, in response to the request, reproducing a content file corresponding to a predetermined time event set based on position information of the terminal via an Application Programming Interface (API); and
an Access Point (AP) for controlling that the content file being reproduced using the API of the wireless network.

2. The wireless network system of claim 1, wherein the portable terminal further provides a specified direction using a magnetic sensor therein based on position information acquired from a position information Data Base (DB).

3. The wireless network system of claim 1, further comprising
a Digital Media Server (DMS) for storing a plurality of multimedia content files and providing any of them in response to a request; and
a Digital Media Controller (DMC) for requesting for a desired content file to be reproduced from among the plurality of multimedia content files.

4. The wireless network system of claim 1, wherein the API of the wireless network is a standardized API for compatibility between the plurality of digital devices in a Digital Living Network Alliance (DLNA) middleware based network.

5. The wireless network system of claim 1, wherein the content file corresponding to the predetermined time event comprises image and sound information associated with the Azan.

6. A method of displaying an event using a portable terminal, the method comprising:
identifying position information registered in the portable terminal;
calculating a predetermined time based on the identified position information and setting an event occurring at the calculated time; and
matching a predetermined content file to the set event, searching for at least one device capable of reproducing the content file, and transmitting the content file to the found device through an Application Programming Interface (API) of a wireless network when the event occurs.

7. The method of claim 6, further comprising displaying a specified direction with bearings of east, west, south, and north when the event occurs.

8. The method of claim 6, wherein the found device receives a request message for temporarily stopping a content file being reproduced from the portable terminal.

9. The method of claim 6, wherein the found device transmits the content file transmitted from the portable terminal to a plurality of devices in the wireless network through an Access Point (AP).

10. An apparatus for displaying an event using a portable terminal, comprising:
a position information Data Base (DB) for registering, storing, and managing position information of a corresponding city of a corresponding country, which is identified through a user's input or periodically transmitted serving Base Station (BS) information;
a calculator for calculating a predetermined time based on position information output from the position information DB; and
a controller for setting an event occurring at the predetermined time calculated by the calculator, matching a predetermined content file to the set event, searching for at least one device capable of reproducing the content file, and transmitting the content file to the found device through an Application Programming Interface (API) of a wireless network when the event occurs.

11. The apparatus of claim 10, wherein the position information of the corresponding city of the corresponding country is identified through an international telephone country code identification number directly input by a user or acquired from current serving Base Station (BS) information.

12. The apparatus of claim 10, wherein the controller sets an access to the found device by generating a message in a format based on a corresponding protocol of the wireless network to which the found device belongs.

13. The apparatus of claim 10, further comprising a magnetic sensor unit for detecting magnetic north information where the portable terminal located.

14. The apparatus of claim 13, wherein the controller controls to display a Qiblah direction based on a position of the magnetic north information detected by the magnetic sensor unit.
